(19) United States
(12) Patent Application Publication
(10) Pub. No.: US 2014/0032474 A1
(43) Pub. Date: Jan. 30, 2014

(54) FORECASTING AN OUTCOME OF AN ELECTION

(71) Applicants: Patrick Hummel, Cupertino, CA (US); David Rothschild, New York, NY (US)

(72) Inventors: Patrick Hummel, Cupertino, CA (US); David Rothschild, New York, NY (US)

(73) Assignee: Yahoo! Inc., Sunnyvale, CA (US)

(21) Appl. No.: 13/559,527

(22) Filed: Jul. 26, 2012

(51) Int. Cl. G06N 5/02

(52) U.S. Cl. 706/52

(57) ABSTRACT

Embodiments of methods or apparatus for forecasting one or more election outcomes are described.

### BACKGROUND

1. Field

This disclosure relates to forecasting, such as an outcome of an election, for example.

2. Information

During an election year, advertisers and/or media networks may expend energy and/or resources covering election campaigns and/or their outcomes. As an election season evolves, larger and larger amounts of attention may be paid to a candidate's message, ideology, proposed policies, and/or other attributes. As an election approaches, candidates' advertisements may dominate television and/or cable channels as well as Internet-type media networks. Thus, especially in a tight election, the public's curiosity in an outcome of an election may be particularly intense.

In some instances, polling data, such as may be obtained by way of phone solicitation, for example, may be used to predict an outcome of an election. In other instances, exit polls may be used to ascertain or to estimate a likelihood of a particular candidate winning an election. However, these methods and/or others may represent costly and/or complicated methods of predicting an outcome of an election. Additionally, some of these methods may not be particularly accurate unless performed immediately prior to an election or perhaps even during an election as voters are exiting polling locations. At such advanced stages of an election season, a candidate may, therefore, have little or no time to adjust his or her message to voters, which may be undesirable for the candidate. Further, voters may prefer having at least some sense of an outcome of an election a bit further in advance of an election.

### BRIEF DESCRIPTION OF DRAWINGS

Claimed subject matter is particularly pointed out and distinctly claimed in the concluding portion of the specification. However, both as to organization and/or method of operation, together with objects, features, and/or advantages thereof, may best be understood by reference to the following detailed description if read with the accompanying drawings in which:

FIG. 1 is a diagram of an embodiment that includes an apparatus for forecasting an outcome of an election;

FIG. 2 is a flow diagram illustrating an embodiment of a system for forecasting an outcome of an election; and

FIGS. 3 and 4 are flow diagrams illustrating embodiments of methods of forecasting an outcome of an election.

Reference is made in the following detailed description to accompanying drawings, which form a part hereof, wherein like numerals may designate like parts throughout to indicate corresponding and/or analogous components. It will be appreciated that components illustrated in the figures have not necessarily been drawn to scale, such as for simplicity and/or clarity of illustration. For example, dimensions of some components may be exaggerated relative to other components. Further, it is to be understood that other embodiments may be utilized. Furthermore, structural and/or other changes may be made without departing from claimed subject matter. It should also be noted that directions and/or references, for example, up, down, top, bottom, and so on, may be used to facilitate discussion of drawings and/or are not intended to restrict application of claimed subject matter. Therefore, the following detailed description is not to be taken to limit claimed subject matter and/or equivalents.

### DETAILED DESCRIPTION

Reference throughout this specification to “one example,” “one feature,” “one embodiment,” “an example,” “a feature,” or “an embodiment” means that a particular feature, structure, or characteristic described in connection with a feature, example or embodiment is included in at least one feature, example or embodiment of claimed subject matter. Thus, appearances of the phrase “in one example,” “an example,” “in one feature,” “a feature,” “an embodiment,” or “in one embodiment” in various places throughout this specification are not necessarily all referring to the same feature, example, or embodiment. Furthermore, particular features, structures, or characteristics may be combined in one or more examples, features, or embodiments.

Media networks, such as the Yahoo!™ network, for example, are increasingly seeking ways to keep users within their networks. A media network may comprise, for example, an Internet website or group of websites having one or more sections. As an example, the Yahoo!™ network comprises websites located within different categorized sections, such as sports, finance, news, games, and social media, to name just a few among many possible non-limiting examples. A media network may comprise an Internet-type network or a non-Internet type network, for example.

The more users that remain within a media network for extended periods of time, the more valuable a network may become to potential advertisers and, typically, the more money advertisers may pay to advertise to users, for example, via that media network. In an implementation, applications, such as search engines, games, news feeds, and/or forecasting tools that may be provided to a client device by way of a server or other computing platform, for example, may entice individuals to remain within a network, such as for a relatively extended period of time. Additionally, as materials presented to users of a media network's forecasting tools, for example, are periodically or otherwise, such as occasionally, updated, users may be persuaded to revisit a media network, such as on a regular basis, such as perhaps over a period of weeks, months, or longer, for example. Thus, users may, in effect, remain loyal to a media network for other applications, and may perhaps make greater use of search engines, games, news feeds, and/or so forth, if they believe or come to believe that the media network provides accurate and/or reliable forecasting tools and/or services.

According to one or more implementations, as discussed herein, a system or method may be provided for estimating or forecasting an outcome of an election, for example, to one or more users, such as via a media network, for example. A forecasting tool may be provided for evaluating historical data, wherein historical data may comprise non-transitory information states physically stored, such as electronically, a repository or database, such as, for example, in a structured, computerized election outcome database. For example, in an embodiment, regressor functions may be generated from historical data. For example, regression techniques may be employed so that election outcomes may be predicted using attributes of prior elections and associated election outcomes. For example, an independent variable, which may, for example, take the form of attributes of prior elections may be employed to predict a response variable, such as, for example, an election outcome. An independent variable may also be referred to as a regressor variable and may be employed to estimate a dependent variable which may reflect an aspect of historical data that may comprise an inherent characteristic, meaning, in this context, that it may provide at least some amount explanatory power with respect to resulting response variables. Regressor variables may comprise, as a few non-limiting examples, incumbent president advantage, year-influenced weighting factors, candidate voting records, regional and/or home state indicators, prior experience indicators, in-state personal income growth indicators, and/or others, which may be employed to generate a forecasting function so that a response variable, such as an outcome of a future election, at a state level, for example, may be predicted.

In an embodiment, an approach may be utilized for extracting a plurality of regressors (e.g., regressor variables) to approximate or estimate independent variables that contribute to a plurality of outcomes of historical elections (e.g., response variables). An approach may comprise, as an illustrative example, forecasting an outcome of an election, such as, at a state level based, at least in part, on a function that comprises a plurality of regressors that may approximate dependent variables inherent within information states that may comprise a plurality of historical election outcomes, for example. In another embodiment, a computing platform, such as may comprise a computing device, for example, may be utilized to forecast an outcome of an election, such as a national election at a US state level, for example, based, at least in part, on regressor functions that may result, at least in part, from using one or more regression techniques in connection with a database or other repository, such as one comprising information states representing outcomes of historical elections. Although claimed subject matter is, of course, not limited in scope to illustrative examples described herein.

In this context, as indicated, a regression technique may be employed with respect to a set of historical election outcomes, for example, to extract regressors that may approximate dependent variables characteristic of information states corresponding to election outcomes, for example. The term “forecasting function” refers to a mathematical or logical operation in which one or more regressor functions, indicators, variables, operators, or combinations thereof may be generated to estimate or to predict an outcome of a future election.

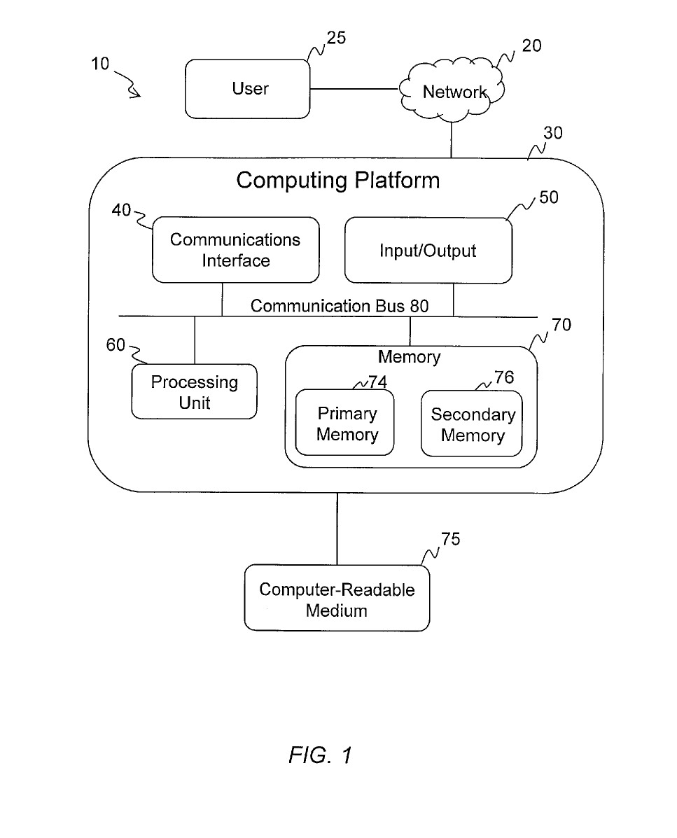

FIG. 1 is a diagram of an embodiment 10. Embodiment 10 may, for example, be employed to forecast an outcome of an election. In FIG. 1, a computing platform 30 may comprise, for example, a processor 60 (also referred to as a processing unit) and a memory 70 coupled by a bus 80. A processor and a memory coupled by a bus comprises an example embodiment of a computing device, although computing platform 30 includes more components in this embodiment, as illustrated in FIG. 1. For example, computing platform 30, which comprises a computing device, further includes a communications interface 40, and an input/output module 50. Likewise, memory 70, as illustrated, may comprise primary memory 74 and secondary memory 76, for example.

In FIG. 1, a user, such as 25, may communicate with computing platform 30 by way of a network connection through network 20, such as the Internet, for one example embodiment. Although the computing platform of FIG. 1 shows the above-identified components, claimed subject matter is not limited to computing platforms comprising only these components as other implementations may include alternative arrangements that may include additional components, fewer components, or components that may operate differently while achieving similar results.

Processor or processing unit 60 may be representative of one or more circuits, such as digital circuits, to perform at least a portion of a computing procedure or process. By way of example but not limitation, processing unit 60 may comprise one or more processors (or sub-processors, for example), controllers, microprocessors, microcontrollers, application specific integrated circuits, digital signal processors, programmable logic devices, field programmable gate arrays, the like, or any combination thereof.

Memory 70 may be representative of any signal storage mechanism. Memory 70 may include, for example, primary memory 74 and/or secondary memory 76, although nothing prevents a use of additional memory circuits, mechanisms, or combinations thereof. Memory 70 may comprise, for example, random access memory, read only memory, or one or more data storage devices or systems, such as, for example, a disk drive, an optical disc drive, a tape drive, a solid state memory drive, to name just a few examples. Memory 70 may be utilized to store state or signal information relating to outcomes of previous elections, for example. Memory 70 may also comprise a memory controller for accessing computer readable-medium 75, also illustrated in FIG. 1, that may carry and/or make accessible content, code, and/or instructions, for example, such as may be executable by processing unit 60 or some other controller or processor capable of executing instructions, for example.

Network 20 may comprise one or more communication links, processes, and/or resources to support exchanging communication signals between a device (not shown), such as a client (not shown) which may be operated by a user, such as 25, for example, and computing platform 30. For example, in an embodiment, computing platform 30 may comprise one or more servers. By way of example but not limitation, network 20 may include wireless and/or wired communication links, telephone or telecommunications systems, Wi-Fi networks, Wi-MAX networks, the Internet, the web, a local area network (LAN), a wide area network (WAN), or any combination thereof.

The term “computing platform” as used herein refers to a system and/or a device that includes an ability to process and/or store data in the form of signals and/or states, such as a computing device. Thus, a computing platform, in this context, may comprise hardware, software, firmware, or any combination thereof (other than software per se). Computing platform 30, as depicted in FIG. 1, is merely one such example, and the scope of claimed subject matter is not limited to this particular example. For one or more embodiments, a computing platform may comprise any of a wide range of digital electronic devices, including, but not limited to, personal desktop or notebook computers, high-definition televisions, digital versatile disc (DVD) players and/or recorders, game consoles, satellite television receivers, cellular telephones, personal digital assistants, mobile audio and/or video playback and/or recording devices, or any combination of the above. Further, unless specifically stated otherwise, a process as described herein, with reference to flow diagrams and/or otherwise, may also be executed and/or affected, in whole or in part, by a computing platform.

Memory 70 may store cookies relating to one or more users, such as user 25, for example, and may also comprise a computer-readable medium that may carry and/or make accessible content, code and/or instructions, for example, executable by processing unit 60 or some other controller or processor capable of executing instructions, for example. User 25 may make use of an input device, which may comprise a computer mouse, stylus, track ball, keyboard (e.g., virtual or non-virtual), or any other device capable of receiving as an input a physical motion or the like, such as a mouse click, a key being pressed or a similar example, to generate a signal, for example, to be communicated, such as to another device, across, a network, etc.

A computer-readable (storage) medium, such as computer-readable medium 75 of FIG. 1, typically may be non-transitory and/or comprise a non-transitory device. In this context, a non-transitory storage medium may include a device that is tangible, meaning that the device has a concrete physical form, although the device may change its physical state. Thus, for example, non-transitory refers to a device remaining tangible despite a change in state.

User 25 may make use of client resources, such as a computing platform that may comprise a computing device, as one example. Likewise, a client computing platform that may comprise a computing device may include a browser utilized to, e.g., view or otherwise access content, such as, from the Internet, for example. A browser may comprise a standalone application, or an application embedded in or forming at least part of another program or operating system, etc. Client resources, such as a computing platform that may comprise a computing device, as one example, may also include or present a graphical user interface. An interface, such as GUI, may include, for example, an electronic display screen or various input or output devices. Input devices may include, for example, a microphone, a mouse, a keyboard, a pointing device, a touch screen, a gesture recognition system (e.g., a camera or other sensor), or any combinations thereof, etc., just to name a few examples. Output devices may include, for example, a display screen, speakers, tactile feedback/output systems, or any combination thereof, etc., just to name a few examples. In an example embodiment, user 25 enter may submit a request for content or a request to access content via an interface, although claimed subject matter is not limited in scope in this respect. Signals may be transmitted via client resources to a server system, such as computing platform 30, for example, via a communications network, such as network 20, for example. A variety of approaches are possible and claimed subject matter is intended to cover such approaches.

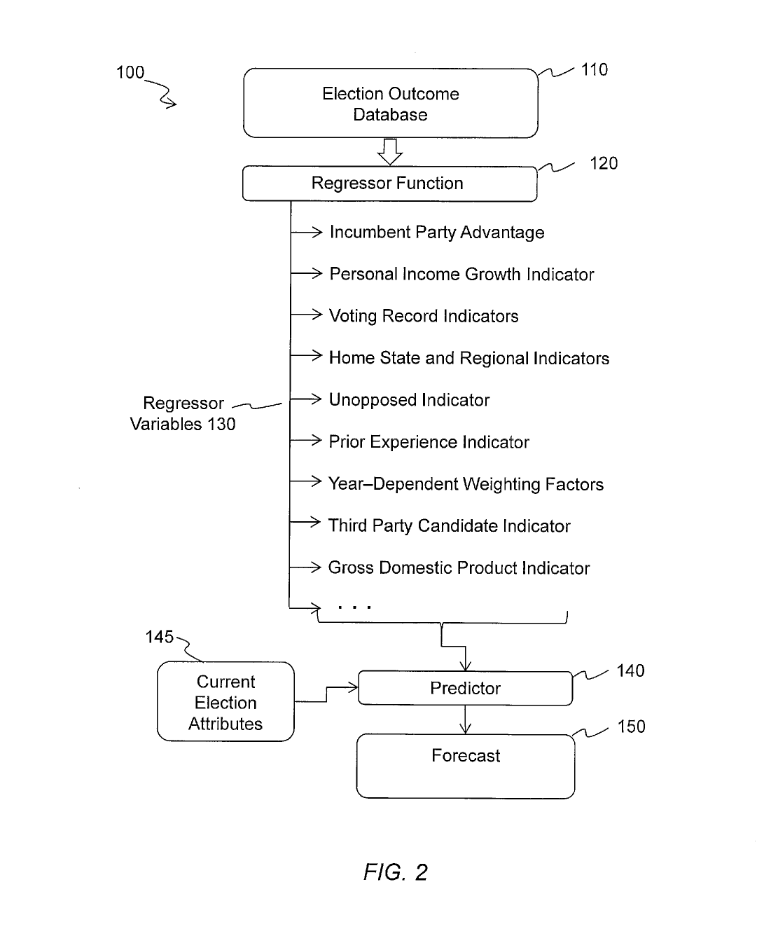

FIG. 2 is a schematic diagram illustrating an embodiment 100 of a system for forecasting an outcome of an election. In FIG. 2, an election outcome database 110 may comprise information states corresponding to historical data of past elections. In an embodiment, historical data may comprise information states pertaining to election outcomes as well as additional and/or related historical information concerning economic, polling, social and/or demographic matters, as well as statewide and/or regional issues, which may have at least partially influenced election outcomes. Historical data stored in a repository, such as database 110, for example, may capture one or more relationships between independent and response variables related an election, for example, such as election attributes and election outcomes, respectively.

A regressor function may be generated by, in effect, extracting regressor variables, such as by regressor function 120, from election outcome database 110, for example, through the use of regression techniques, for example, to identify regression variables that may be used to estimate or approximate dependent variables, for example. Regressor variables 130 may, for example, comprise values of prior or past election attributes. Thus, current election attributes 145, may be utilized to compute a regression function comprising regressor variables to generate a current election outcome prediction, for example.

In an example implementation, a predictor 140 may comprise regression variables substantially in accordance with the expression:

Y=β₀+Σⱼ₌₁^{p}βⱼXⱼ+ε (1)

In expression (1), for example, Y may indicate a response variable, and X₁, . . . Xₚ may indicate regressor variables. Quantities β₀, . . . . βₚ may represent weighting factors (e.g. coefficients) whose values may be estimated using an appropriate regression technique, such as weighted least squares, straight line linear regression, minimax, or other suitable technique, for example. The quantity ε may represent a remaining error term.

Accordingly, in an example embodiment, use of expression (1), for example, may allow regressor variables to be employed to forecast a percentage of a major party vote, such as for a Democratic candidate or for a Republican candidate, that may be received in an election, such as in a given state in a US presidential election, such as before and/or after vice presidential candidates have been announced using expression (4) provided herein, for example. In this context, the term major party refers to one of two political parties in a two party system, such as currently in the United States, the Democratic Party or the Republican Party. Of course, claimed subject matter is not limited in scope to particular parties or to particular assignment of values, such as described below.

In an example embodiment, current election attributes, for example, may be used as values for regression variables in a regression function to forecast a percentage of a major party vote, such as, for example, may be received by a Democratic candidate in gubernatorial and/or senatorial election, such as, for example, using one or more of expressions (5) and (6) provided herein. Regressor variables 130 for an embodiment may be described, at least in part, below.

One or more regressor variables 130 may comprise, for example, an estimate of a measure of party popularity, which may be proportional to a first order function that includes a sitting president's approval rating reflected in a poll, such as a well-known poll, like the Gallup poll, for example, taken approximately at June 15 of an election year, as a non-limiting example. A measure of party popularity may be expressed as:

APPROVE=(Approval_{(Gallup Poll, June 15th)}−50)*INCPARTY (2)

In expression (2), a variable “INCPARTY” may be set equal to −1.0, for example, if a sitting president is a Republican and may be set equal to +1.0 if a sitting president is a Democrat, for example, although claimed subject matter is not limited in scope in this respect. For example, Republican and Democrat may be reversed and some form of scaling may likewise be employed, for example. Of course, again, claimed subject matter is not limited in scope to particular major parties or to particular assignment of values. However, using expression (2), a measure of a party's popularity may be estimated since the value of this expression is greater if the party is the incumbent party and the incumbent party has a higher approval rating or if the opposing party is the incumbent party and the incumbent party has a lower approval rating. A forecasting function may comprise a positive slope if a variable represents an incumbent party, such as INCPARTY, and may comprise a negative slope if a variable representing a non-incumbent party.

Employing a similar approach, regressor variables 130 may also comprise “INCPARTY2,” which may be set equal to −1.0 if a Republican, for example, has been president for at least two consecutive terms and may be set equal to +1.0 if a Democrat, for example, has been president for at least two consecutive terms. If neither a Republican nor a Democrat has been president for at least two consecutive terms, INCPARTY2 may be set to a different value, such as 0.0, for example. Of course, again, claimed subject matter is not limited in scope to particular parties or to particular assignment of values.

Regressor variables 130 may additionally comprise a variable “INCOME,” which may, for example, denote a percentage change, such as growth, in personal income in a state during a time period, such as from the start of the year before the election and continuing to the end of the first quarter in the election year. In an implementation, this period may denote a period beginning on January 1 of the year before the election and ending on March 31 in the year of the election. A quantity such as 9.0, for example, may be subtracted to reflect nominal rather than real growth in personal income. This quantity may be multiplied by INCPARTY, for example, which may be expressed using the following first-order function:

INCOME=(% Change in Personal Income from January 1 in the year before the election to March 31 in the year of the election−9.0)*INCPARTY (3)

In another example, a variable “GDP” may be used to indicate annualized real gross domestic product growth during a time period such as a second quarter of an election year, for example, minus 3.3, again, to reflect real rather than nominal growth, wherein the entire quantity may be multiplied by INCPARTY. In at least one possible example, GDP may be expressed, for example, in the following first-order function:

(GDP_{(second quarter of an election year, annualized)}−3.3)*INCPARTY (3a)

Regressor variables 130 may, for example, additionally comprise a variable “PRESDEV,” which may be used to indicate a difference between a percentage of a major party vote, such as, received by a Democratic presidential candidate, in a particular state, for example, in a previous presidential election and a percentage of a major party vote, such as received by Democratic presidential candidate, nationwide, in a previous presidential election, for example. Regressor variables 130 may further comprise a variable “PRESDEV2,” for example, which may indicate a difference between a percentage of a major party vote, such as received by a Democratic presidential candidate, in a particular state, in an election immediately prior to a recent presidential election and a percentage of a major party vote, such as received by the Democratic presidential candidate, nationwide, immediately prior to a recent presidential election. Of course, again, claimed subject matter is not limited in scope to particular parties or to particular assignment of values.

Regressor variables 130 may additionally comprise a variable “SENDEV,” which may indicate a difference between a percentage of a major party vote, such as received by a Democratic Senate candidate, for a particular state, in a recent preceding election (e.g. six years ago) and a percentage of a major party vote, such as received by a group of Democratic Senate candidates, nationwide, in a preceding election, such as six years ago, for example. In an example, a group of Democratic Senate candidates may comprise perhaps all Democratic Senate candidates that sought election in the most recent election, although claimed subject matter is not limited in scope in this respect

Regressor variables 130 may additionally comprise a variable “ACU,” which may, for example, denote a sum of ratings given by the American Conservative Union (ACU) to senators in the state. The ratings may be given in a year prior to the election, such as, for example, the year immediately preceding the election year, minus an average sum of ACU ratings of the senators in all states provided by the ACU in the year. In particular implementations, the variable “ACU” may suggest that voting records of senators in a state are likely to correlate with the ideology of the state. Thus a state where senators have voting records perceived as more conservative may be assigned a higher-valued indicator, for example. In another example, a related regressor variable “REPACU” may represent an indicator based at least in part on an American Conservative Union voting record rating in a previous year if an incumbent senator is a Republican, and if the incumbent senator is running for reelection, minus an average of indicators for Republican senators. Otherwise, REPACU may be set to a different value, such as 0.0, for example.

It is noted that an aspect related to use of an interest group rating may relate to treatment of voting record by a candidate. For example, if a candidate does not vote for a particular measure, that may be treated as not supporting the measure or it may be ignored for purposes of producing an indicator since there may be a variety of reasons a candidate was unable to vote. For example, the ACU employs that latter approach.

Regressor variables 130 may additionally comprise a variable “HOME” which may indicate that a major party, such as Democrat, for example, presidential candidate's home state has a population of less than 10 million people, as an example, among many possible examples. In this context, the term “home” refers to a geographical association, such as a state or other region, where the candidate may have lived and/or otherwise where the candidate had a career. In an example, HOME may be set equal to 1.0 if a state corresponds to a Democratic presidential candidate's home state, and HOME may be set equal to −1.0 if a state corresponds to a Republican presidential candidate's home state. Otherwise, HOME may be set to 0.0, for example. Regressor variables 130 may additionally comprise a variable “VPHOME,” which may be set equal to 1.0, for example, if a state corresponds to a Democratic vice presidential candidate's home state and a state has a population of less than 10 million people. In an example among many possible examples, VPHOME may be set to −1.0 if a state corresponds to a Republican vice presidential candidate's home state and a state has a population of less than 10 million people. Otherwise, VPHOME may be set to 0.0. Of course, again, claimed subject matter is not limited in scope to particular parties or to particular assignment of values.

In addition to home state indicators for both presidential and vice presidential candidates, regressor variables 130 may additionally comprise variables that denote if a state is within a candidate's home region. For example, a variable “REGHOME” may be set equal to 1.0 if a state is in a Democratic presidential candidate's home region, and set to −1.0 if a state is in a Republican presidential candidate's home region. Otherwise, REGHOME may be set to 0.0, for example. Of course, again, claimed subject matter is not limited in scope to particular parties or to particular assignment of values.

In at least one possible embodiment, regressor variables 130 may include an indicator that may be used to identify a state for which a statewide election is being forecast. For example, a variable “ROCKY” may be set to 1.0 if a state from which one or more historical election outcomes corresponds to a Rocky Mountain state, for example. In one possible example, if an election outcome database comprises historical data from Idaho, Montana, Wyoming, Nevada, Utah, Colorado, Arizona, New Mexico, or Alaska, ROCKY may be set to 1.0, for example, and may be set to 0.0 otherwise. In another example, a variable “SOUTH” may be set to 1.0 if a state from which one or more historical election outcomes corresponds to a southern state, such as, for example, Texas, Oklahoma, Arkansas, Louisiana, Delaware, Maryland, West Virginia, Virginia, Kentucky, Tennessee, North Carolina, South Carolina, Florida, Georgia, Alabama, or Mississippi. If historical data in an election outcome database does not pertain to an election outcome of a southern state, SOUTH may be set to 0.0, for example. In another example, a variable “MIDWEST” may be set to 1.0 if a state from which one or more historic election outcomes corresponds to a Midwestern state, such as, for example, Ohio, Michigan, Illinois, Indiana, Wisconsin, Minnesota, Iowa, Missouri, Nebraska, North and South Dakota, or Kansas. MIDWEST may be set to 0.0 if an election outcome does not correspond to a Midwestern state. Of course, again, claimed subject matter is not limited in scope to particular parties or to particular assignment of values, such as particular regional associations.

In at least one possible embodiment, regressor variables 130 may additionally assist in estimating year-relevant weighting factors. In at least one possible example, ROCKY may be set to 1.0 if a year from which historical data from an election outcome database 110 corresponds to 1980 or earlier, for example. If historical data from election outcome database 110 corresponds to a year after 1980, ROCKY may be set to 0.0, for example. In at least one other possible example, a variable “SOUTH76” may be set equal to 1.0 if historical data in an election outcome database corresponds to the year 1976. Otherwise, SOUTH76 may be set equal to 0.0, for example. In at least one other possible example, a variable “SOUTH80” may be set to 1.0 if historical data in an election outcome database corresponds to 1980 or earlier. Otherwise, SOUTH80 may be set to 0.0, for example. Thus, in certain examples, a first weighting factor may be applied to certain less recent historical election outcomes while a second weighting factor may be applied to certain more recent historical election outcomes, where more recent or less recent reflects a relative time scale relative to a particular year, for example.

In at least one possible embodiment, regressor variables 130 may additionally assist in estimating year-relevant weighting factors that may account, at least in part, for a presence of one or more third-party candidates in one or more historical election outcomes. In this context, the term “third-party” refers to a political party other than one of the two major parties. In certain examples, a year-relevant weighting factor “WALLACE” may represent the percentage of the vote received by George Wallace in the state in the 1968 election if the state is a Southern state and the year is 1972, for example. The variable “WALLACE” may, in an example, be set to 0.0 otherwise. In at least one other example, regressor variables 130 may further comprise year-relevant weighting factors that account for other third-party candidates, such as “ANDERSON,” which may comprise a variable representing the percentage of the vote received by John Anderson in the state in the 1980 election minus Anderson's national vote share in the 1980 election if the year is 1984 and may assume 0.0 otherwise. In another possible embodiment, a year-relevant weighting factor “PEROT” may comprise a variable representing the percentage of the vote received by Ross Perot in the state in the 1996 election minus Perot's national vote share in the 1996 election if the year is 2000 and may assume 0.0 otherwise. Of course, again, claimed subject matter is not limited in scope to particular parties, years, or to particular assignments of values.

In at least one example, regressor variables 130 may include “LEGCHANGE” and “HOME2.” In an implementation, LEGCHANGE may represent a change in the percentage of Democrats in a lower house (e.g. state assembly) of the state legislature as a result of the most recent state legislative elections. A regressor variable “HOME2” may refer to a dummy variable that may be set equal to 1.0 for those instances, for example, in which the state corresponds to the Democratic candidate's home state in the previous presidential election and the state has a population greater than 10 million. The variable “HOME2” may be set equal to −1.0 for those instances, for example, in which the state corresponds to the Republican candidate's home state in the previous presidential election and the state has a population greater than 10 million. HOME2 may be set equal to 0.0 otherwise.

In at least one example, forecasting function 150 may use current election attributes 145 as values for regressor variables 130 in which coefficients or weighting factors may be obtained from regression applied to historical data, as previously explained. In an example, a forecasting function that may be used to forecast a percentage of a major party vote estimated to be received, such as by a Democratic candidate in a state in a US presidential election, may be expressed as:

47.129+0.403*APPROVE+2.936*INCPARTY−1.611*INCPARTY2+0.258*INCOME+0.681*PRESDEV+0.112*PRESDEV2−0.018*ACU+0.086*LEGCHANGE+5.112*HOME−2.701*HOME2+0.688*REGHOME+13.468*SOUTH76−0.208*WALLACE+0.539*ANDERSON−0.755*PEROT (4)

In expression (4), coefficients such as 47.129, 0.403, 2.936, −1.611, and so forth may represent weighting factors computed by way of a regression technique applied to historical election outcomes, as previously described. Variables such as “APPROVE,” “INCPARTY,” “INCPARTY2,” and so forth may represent current election attributes, as previously described. Current election attributes may also affect expression (4) via a ± sign, which may indicate whether a quantity is subtracted from or added to other components of expression (4). Further, it should be noted that claimed subject matter is not limited to identified weighting factors and/or variables. For example, claimed subject matter is not intended to be limited to a weighting factor of 2.936 estimated using an approach previously described to estimate a size of an incumbent party advantage. In other implementations, for example, a weighting factor may equal values as low as 2.5 or perhaps as high as 3.5 or higher.

In at least one example, regressor variables 130 may comprise additional variables that may be used to forecast a percentage of a major party vote, such as may be received by a Democratic candidate in a gubernatorial election. For example, a variable “GOVINC,” may denote a variable set equal to 1.0, for example, if an incumbent Democratic governor is running for reelection in a state. GOVINC may be set to −1.0 if an incumbent Republican governor is running for reelection in a state, for example. If neither condition is true, GOVINC may be set to 0.0, for example. In another example, a variable “GOVINC92” may be used to indicate if a year from which historical data from election outcome database 110 corresponds to 1992 or later. For example, GOVINC92 may be set equal to GOVINC if historical election outcome data corresponds to 1992 or later, and may be set to 0.0 otherwise, for example. Of course, again, claimed subject matter is not limited in scope to particular parties or to particular assignment of values.

In at least one example, regressor variables 130 may comprise variables that may be used to forecast a midterm election. In an example, the variable “MIDTERM” may denote a variable that is set equal to 1.0 if an election being forecast corresponds to a midterm election and a Democrat is president. If an election being forecast corresponds to a midterm election and a Republican is president, MIDTERM may be set to −1.0, for example. If neither condition is true, MIDTERM may be set to 0.0, for example. Of course, again, claimed subject matter is not limited in scope to particular parties or to particular assignment of values.

In at least one example, regressor variables 130 may comprise a variable LEGCOMP, which may indicate a fraction of major party state legislators in a lower house (e.g. state assembly) for a major party, such as for example, Democrats. In another example, regressor variables 130 may comprise a variable “UNOPPOSED,” which may be set equal to 1.0 if a major party candidate, such as Democrat, ran unopposed, such as unopposed by a Republican candidate, in a U.S. Senate election, perhaps six years in the past. UNOPPOSED may be set to −1.0, for example if a Republican candidate ran unopposed, such as unopposed by a Democratic candidate, perhaps six years in the past. UNOPPOSED may be set to 0.0 otherwise, for example. Of course, again, claimed subject matter is not limited in scope to particular parties or to particular assignment of values.

In example implementations, regressor variables 130 may additionally comprise variables that relate to a candidate's prior experience. In a possible example, a variable “GOV” may be set to 1.0 if a major party candidate, such as a Democratic candidate, held a governor's office while an alternate major party candidate, such as a Republican candidate, did not. GOV may be set to −1.0, for example, if a Republican candidate held a governor's office and a Democratic opponent did not. GOV may be set to 0.0 otherwise, for example. In another possible example, a variable “GOV2” may be set to 1.0, for example, if a Democratic candidate is not an incumbent governor and the candidate previously held a governor's office but a Republican opponent's previous position did not include a governor's office or the opponent is an incumbent governor, for example. GOV2 may be set to −1.0 if a Republican candidate is not an incumbent governor and the candidate previously held a governor's office but a Democratic opponent did not include a governor's office or the opponent is an incumbent governor. Otherwise, for example, GOV2 may be set to 0.0. Of course, again, claimed subject matter is not limited in scope to particular parties or to particular assignment of values.

In another possible example, regressor variables 130 may include “SEN,” which may indicate if a candidate's prior experience, such as, for example, a candidate's last position having been a US Senator. Regressor variables 130 may include “HOUSE,” which may indicate if a candidate's prior experience as a member of the US House of Representatives. Regressor variables may include “CABINET,” which may indicate a candidate's prior experience as a member of a president's Cabinet. Regressor variables may include “MAYOR,” which may indicate a candidate's prior experience as a mayor. Regressor variables may include “LTGOV,” which may indicate a candidate's prior experience as a lieutenant governor. Regressor variables may include “LEG,” which may indicate a candidate's prior experience as a state legislator. Regressor variables may include “STATE,” which may indicate a candidate's prior experience as another statewide office, such as a state treasurer, secretary of a US state, or other statewide office. Regressor variables may also include “LOCAL” which may indicate a candidate's prior experience as a holder of a local office, such as County Commissioner, Tax Assessor, or other local office. Regressor variables may also include “BUS,” which may indicate a candidate's prior experience as a business executive. In an example, one or more of SEN, HOUSE, CABINET, MAYOR, LTGOV, LEG, STATE, LOCAL, BUS may be set to 1.0, for example, to indicate that a Democratic candidate's last position has been one of the aforementioned while a Republican opponent has not held a corresponding office. SEN, HOUSE, CABINET, MAYOR, LTGOV, LEG, STATE, LOCAL, BUS may be set to −1.0 to indicate that a Republican candidate's last position has been one of the aforementioned while a Democratic opponent has not held the corresponding office. In the aforementioned instances, if a variable is not assigned to 1.0 or −1.0, the variable may be set to 0.0, for example. Of course, again, claimed subject matter is not limited in scope to particular parties or to particular assignment of values.

Regressor variables may include “SENINC,” which may be set to 1.0 if an incumbent major party senator, such as a Democrat, is running for reelection in a state. SENINC may be set to −1.0, for example, if an incumbent alternate major party senator, such as a Republican, is running for reelection in that state. Otherwise, SENINC may be set to 0.0, for example. In another possible example, a variable SENINC84 may be used to indicate that historical data from an election outcome database corresponds to elections in the years 1984 or later. In the event that historical data corresponds to 1984 or later, SENINC84 may be set equal to SENINC, for example. The variable “SENINC” may be set to 0.0 otherwise, for example.

In at least one example, regressor variables 130 may employ current election attributes 145 in forecasting function 150 to generate a prediction. In an example, a forecasting function that may be used to forecast a percentage of a major party vote, such as that may be received by a Democratic candidate in a gubernatorial election, for example, may be expressed as:

43.975+11.073*GOVINC+3.341*GOVINC92−2.598*MIDTERM+0.122*LEGCOMP+0.101APPROVE2+0.199*GDP−2.278*MIDWEST+4.894*SOUTH80+5.936*GOV2+9.401*SEN+7.229*HOUSE+9.436*CABINET+6.575*MAYOR+4.908*LTGOV+4.433*LEG+7.040*STATE+5.187*LOCAL+6.854*BUS (5)

In expression (5), coefficients such as 43.975, 11.073, and so forth may represent weighting factors computed by way of a regression technique applied to historical election outcomes, as previously described, for example. Variables such as “GOVINC,” “MIDTERM,” “LEGCOMP,” and so forth may employ as values current election attributes to compute a prediction from a forecasting function, such as expression (5). Further, it should be noted that claimed subject matter is not limited to identified weighting factors and/or variables, as previously described.

In at least one example, regressor variables 130 may employ current election attributes 145 as values in forecasting function 150 that may be used to generate a prediction or a forecast, such as a percentage of a major party vote that may be received by a Democratic candidate in a Senate election. For example, a forecasting function may be expressed as:

46.438+8.803*SENINC+4.015*SENINC84−2.787*MIDTERM+0.343*PRESDEV+0.112*SENDEV+0.082*LEGCOMP+0.131*APPROVE+0.221*INCOME+0.086*REPACU+10.847*GOV+8.044*HOUSE+6.942*CABINET+6.905*MAYOR+6.864*LTGOV+4.198*LEG+7.559*STATE+7.530*LOCAL+5.853*BUS−5.028*UNOPPOSED. (6)

In expression (6), coefficients such as 46.438, 8.803, and so forth may represent weighting factors computed by way of a regression technique applied to historical election outcomes. Variables such as “SENINC,” “MIDTERM,” and so forth may employ current election attributes as values in forecasting function, such as expression (6), to generate a prediction. Further, it should be noted that claimed subject matter is not limited to identified weighting factors and/or variables, as previously described.

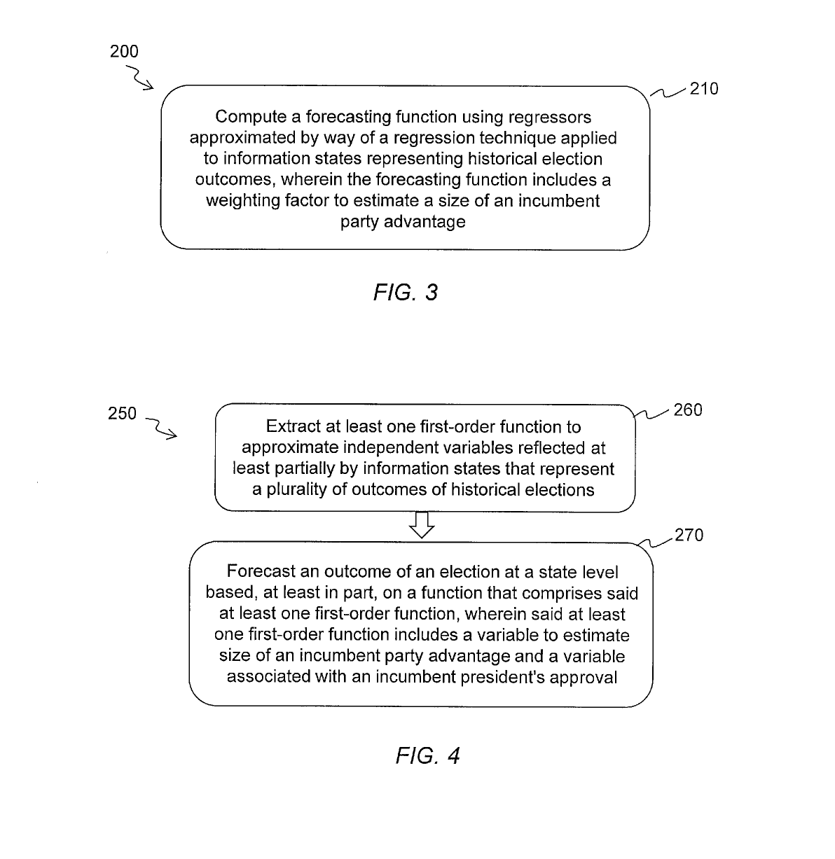

FIGS. 3 and 4 are flow diagrams 200 and 250, respectively, illustrating embodiment of methods of forecasting an outcome of an election. In some example implementations, an apparatus, such as illustrated in FIG. 1, for example, may be suitable for performing a method, such as illustrated in FIGS. 3-4. Likewise, alternative arrangements of components in other example implementations are possible. Furthermore, an embodiment of claimed subject matter may include additional blocks or alternate other than those shown in FIGS. 3-4. An embodiment of a method may include block 210, which includes computing a forecasting function using regressors approximated by way of a regression technique applied to information states representing historical election outcome and may include a weighting factor to estimate a measure of party popularity, for example

An embodiment 250 of a method, such as the method of FIG. 4, may include block 260 which may comprise extracting at least one first-order function to approximate dependent variables such as may be reflected at least partially by information states that represent a plurality of outcomes of historical elections. The method may continue at block 270 which may include forecasting an outcome of an election at a state level based, at least in part, on a function that comprises at least one first order function.

The terms, “and”, “or”, and “and/or” as used herein may include a variety of meanings that also are expected to depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein may be used to describe any feature, structure, and/or characteristic in the singular and/or may be used to describe a plurality or some other combination of features, structures and/or characteristics. Though, it should be noted that this is merely an illustrative example and claimed subject matter is not limited to this example.

In the preceding detailed description, numerous specific details have been set forth to provide a thorough understanding of claimed subject matter. However, it will be understood by those skilled in the art that claimed subject matter may be practiced without these specific details. In other instances, methods and/or apparatuses that would be known by one of ordinary skill have not been described in detail so as not to obscure claimed subject matter. Some portions of the preceding detailed description have been presented in terms of logic, algorithms and/or symbolic representations of operations on binary signals or states stored within a memory of a specific apparatus or special purpose computing device or platform. In the context of this particular specification, the term specific apparatus or the like includes a general purpose computing device, such as general purpose computer, once it is programmed to perform particular functions pursuant to instructions from program software. Algorithmic descriptions and/or symbolic representations are examples of techniques used by those of ordinary skill in the signal processing and/or related arts to convey the substance of their work to others skilled in the art. An algorithm is here, and generally, is considered to be a self-consistent sequence of operations and/or similar signal processing leading to a desired result. In this context, operations and/or processing involve physical manipulation of physical quantities. Typically, although not necessarily, such quantities may take the form of electrical and/or magnetic signals and/or states capable of being stored, transferred, combined, compared or otherwise manipulated as electronic signals and/or states representing information. It has proven convenient at times, principally for reasons of common usage, to refer to such signals and/or states as bits, data, values, elements, symbols, characters, terms, numbers, numerals, information, and/or the like. It should be understood, however, that all of these or similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining”, “establishing”, “obtaining”, “identifying”, “selecting”, “generating”, and/or the like may refer to actions and/or processes of a specific apparatus, such as a special purpose computer and/or a similar special purpose computing device. In the context of this specification, therefore, a special purpose computer and/or a similar special purpose computing device is capable of manipulating and/or transforming signals and/or states, typically represented as physical electronic and/or magnetic quantities within memories, registers, and/or other information storage devices, transmission devices, and/or display devices of the special purpose computer and/or similar special purpose computing device. In the context of this particular patent application, the term “specific apparatus” may include a general purpose computing device, such as a general purpose computer, once it is programmed to perform particular functions pursuant to instructions from program software.

In some circumstances, operation of a memory device, such as a change in state from a binary one to a binary zero or vice-versa, for example, may comprise a transformation, such as a physical transformation. With particular types of memory devices, such a physical transformation may comprise a physical transformation of an article to a different state or thing. For example, but without limitation, for some types of memory devices, a change in state may involve an accumulation and/or storage of charge or a release of stored charge. Likewise, in other memory devices, a change of state may comprise a physical change, such as a transformation in magnetic orientation and/or a physical change or transformation in molecular structure, such as from crystalline to amorphous or vice-versa. In still other memory devices, a change in physical state may involve quantum mechanical phenomena, such as, superposition, entanglement, and/or the like, which may involve quantum bits (qubits), for example. The foregoing is not intended to be an exhaustive list of all examples in which a change in state form a binary one to a binary zero or vice-versa in a memory device may comprise a transformation, such as a physical transformation. Rather, the foregoing is intended as illustrative examples.

While there has been illustrated and/or described what are presently considered to be example features, it will be understood by those skilled in the relevant art that various other modifications may be made and/or equivalents may be substituted, without departing from claimed subject matter. Additionally, many modifications may be made to adapt a particular situation to the teachings of claimed subject matter without departing from the central concept(s) described herein. Therefore, it is intended that claimed subject matter not be limited to the particular examples disclosed, but that such claimed subject matter may also include all aspects falling within appended claims and/or equivalents thereof.

1. A method comprising:
computing a forecasting function using regressors approximated by way of a regression technique applied to information states representing historical election outcomes, wherein
said forecasting function includes a weighting factor to estimate an advantage of an incumbent party.

2. The method of claim 1, wherein said weighting factor that represents said influence of said incumbent party comprises a value of magnitude approximately between approximately 2.5 and approximately 3.5.

3. The method of claim 2, wherein said weighting factor comprises a positive multiplier for a first incumbent party or a negative multiplier for a second incumbent party.

4. The method of claim 1, wherein said forecasting function further comprises at least one regressor applied to certain ones of said historical election outcomes.

5. The method of claim 4, wherein said at least one regressor comprises a year-relevant weighting factor.

6. The method of claim 5, wherein said at least one regressor comprises:
at least a first weighting factor for certain more recent ones of said historical election outcomes, and
at least a second weighting factor for certain less recent ones of said historical election outcomes, wherein
said at least a second weighting factor is greater than said at least a first weighting factor.

7. The method of claim 1, wherein said forecasting function further comprises:
a variable that represents a voting record of a candidate.

8. The method of claim 7, wherein said forecasting function further comprises:
a variable representing proximity of said voting record of said candidate indicates a proximity of a candidate's with a perceived political center.

9. The method of claim 1, wherein said forecasting function further comprises:
a variable that indicates a population of a home state of said candidate.

10. The method of claim 9, wherein said forecasting function further comprises:
changing a value of a weighting factor if said candidate has run unopposed in one of said historical elections.

11. The method of claim 1, wherein said forecasting function further comprises:
at least one variable that indicates said candidate's prior experience.

12. The method of claim 11, wherein said forecasting function further comprises:
at least one weighting factor for said prior experience comprising holding an office selected from the group essentially consisting of US Senator, US Representative, Governor, Lieutenant Governor, State Senator, State Representative, United States Cabinet, Mayor, and local office.

13. The method of claim 1, wherein said forecasting function further comprises:
a variable that indicates nominal personal income growth.

14. A method comprising:
extracting at least one first-order function to approximate dependent variables at least partially reflected by information states that represent a plurality of outcomes of historical elections; and
forecasting an outcome of an election at a state level based, at least in part, on a function that comprises said at least one first-order function;
wherein said at least one first-order function includes a variable to estimate size of an incumbent party advantage and a variable associated with an incumbent president's approval.

15. The method of claim 14, wherein said at least one first-order function corresponds to nominal personal income growth.

16. The method of claim 14, wherein said forecasting is additionally based, at least in part, on at least one regressor corresponding to a US region involved in at least one of said historical elections.

17. An apparatus comprising:
a computing platform to forecast an outcome of an election at a US state level based, at least in part, on an aggregation of regressor functions that result, at least in part from applying one or more regression techniques to information states representing a plurality of outcomes of historical elections;
wherein said application of said regressor functions includes at least one first-order function; and
wherein said at least one first-order function includes a variable to estimate size of an incumbent party advantage and a variable associated with an incumbent president's approval.

18. The apparatus of claim 17, wherein said computing platform additionally applies said one or more regression techniques to estimate coefficients for independent variables corresponding to dependent variables that contribute at least partially to said plurality of outcomes of historical elections.

19. The apparatus of claim 17, wherein at least one regressor of said aggregation of regressor functions comprises a year-relevant weighting factor.

20. The apparatus of claim 19, wherein said year-relevant weighting factor accounts, at least in part, for the presence of one or more third party candidates in at least one of said plurality of outcomes of historical elections.
